(19) United States
(12) Patent Application Publication
(10) Pub. No.: US 2024/0328509 A1
(43) Pub. Date: Oct. 3, 2024

(54) DRIVING APPARATUS

(71) Applicant: HONDA MOTOR CO., LTD., Tokyo (JP)

(72) Inventor: Keiichi OHISO, Saitama (JP)

(73) Assignee: HONDA MOTOR CO., LTD., Tokyo (JP)

(21) Appl. No.: 18/129,581

(22) Filed: Mar. 31, 2023

(51) Int. Cl. F16H 61/32; B60T 1/00; F16D 23/12; F16H 19/02; F16H 63/04; F16H 63/30

(52) U.S. Cl. CPC F16H 61/32; B60T 1/005; F16D 23/12; F16H 19/02; F16H 63/04; F16H 63/304; B60K 11/02; B60K 25/00; F16D 2023/123; F16H 2061/2869; F16H 2063/3056; F16H 63/3408; F16H 63/3466; F16H 2200/0039; F16N 7/40

(57) ABSTRACT

A driving apparatus includes a rotary electric machine configured to output rotation in a first direction and rotation in a second direction, a fluid pump and an actuator that are configured to operate with the output of the rotary electric machine as power, and a one-way clutch provided between the rotary electric machine and the actuator. The fluid pump is configured to intake and discharge a fluid when at least the rotation in the first direction is input. The one-way clutch is configured to block the rotation in the first direction and transmit the rotation in the second direction. The actuator includes a shift drum configured to rotate in one direction in response to the rotation in the second direction transmitted via the one-way clutch, and a shift fork engaged with the shift drum. The shift fork has a plurality of operating states including at least a first state and a second state, and alternately transitions between the first state and the second state in response to the rotation of the shift drum in the one direction.

### TECHNICAL FIELD

The present invention relates to a driving apparatus.

### BACKGROUND ART

A vehicle includes an auxiliary machine such as a water pump for circulating cooling water for cooling an engine or the like as a power source, and an oil pump for circulating hydraulic oil for operating an automatic transmission or the like and lubricating oil for lubricating the parts. These auxiliary machines are driven, for example, by an engine or by an electric motor provided separately from the engine.

In recent years, there is a vehicle including an electric parking lock mechanism using by-wire technology, that is, a mechanism that automatically locks or releases the lock of (unlocks) a parking mechanism in response to an operation on a switch. When stopping due to a traffic signal or the like, the electric parking lock mechanism automatically operates to lock the lock mechanism, and then releases the lock at the same time as the driver steps on the accelerator pedal. The electric parking lock mechanism includes an electric hydraulic pump and a control unit that controls the electric oil pump.

In a system that drives auxiliary machines by using a plurality of electric motors, the structure may be complicated, the weight may increase, or the cost may increase due to an increase in the number of electric motors. Therefore, in a drive unit described in JP2022-040186A, a fluid pump and a parking lock mechanism are driven by a single electric motor. The drive unit controls the operation of the fluid pump and the parking lock mechanism using the forward rotation and the reverse rotation of the electric motor. The fluid pump is driven only by the forward rotation of the electric motor. On the other hand, the parking lock mechanism is switched from the locked state to the unlocked state by the forward rotation of the electric motor, and is switched from the unlocked state to the locked state by the reverse rotation.

In the drive unit described in JP2022-040186A, the fluid pump is driven by the forward rotation of the electric motor, but the switching from the lock to the unlock of the parking lock mechanism is also performed by the forward rotation of the electric motor. That is, the forward rotation of the electric motor is distributed to the driving of the fluid pump and the switch of the parking lock mechanism.

An aspect of the present disclosure relates to provide a driving apparatus that drives a fluid pump and an actuator by a single rotary electric machine.

### SUMMARY OF INVENTION

According to an aspect of the present disclosure, there is provided a driving apparatus that includes a rotary electric machine configured to output rotation in a first direction and rotation in a second direction opposite to the first direction, a fluid pump and an actuator that are configured to operate with the output of the rotary electric machine as power, and a one-way clutch provided between the rotary electric machine and the actuator and configured to transmit the output of the rotary electric machine to the actuator. The fluid pump is configured to intake and discharge a fluid w % ben at least the rotation in the first direction is input. The one-way clutch is configured to block the rotation in the first direction and transmit the rotation in the second direction. The actuator includes a shift drum configured to rotate in one direction in response to the rotation in the second direction transmitted via the one-way clutch, and a shift fork engaged with the shift drum. The shift fork has a plurality of operating states including at least a first state and a second state, and alternately transitions between the first state and the second state in response to the rotation of the shift drum in the one direction.

### BRIEF DESCRIPTION OF DRAWINGS

FIG. 1 is a diagram illustrating a schematic configuration of an example of a driving apparatus for explaining an embodiment of the present invention;

FIG. 2 is a view showing a configuration of a shift drum of the actuator of FIG. 1;

FIG. 3 is a diagram illustrating a schematic configuration of another example of the driving apparatus;

FIG. 4 is a diagram showing a configuration example of a shift drum of the actuator of FIG. 3; and

FIG. 5 is a view showing another configuration example of the shift drum of the actuator of FIG. 3.

### DESCRIPTION OF EMBODIMENTS

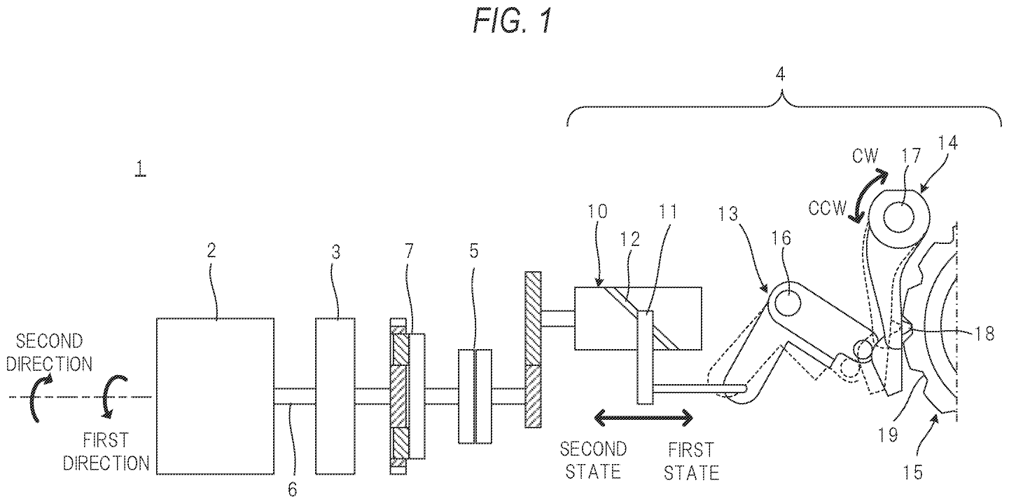

FIG. 1 illustrates an example of a driving apparatus.

A driving apparatus 1 shown in FIG. 1 includes an electric motor 2 which is a rotary electric machine, a fluid pump (hereinafter, simply referred to as a “pump”) 3, and a parking lock mechanism 4 operated by an actuator. The electric motor 2 can output rotation in a first direction and rotation in a second direction opposite to the first direction. Both the pump 3 and the parking lock mechanism 4 operate with the output of the electric motor 2 as power. The driving apparatus 1 further includes a one-way clutch 5. The one-way clutch 5 is provided between the electric motor 2 and the parking lock mechanism 4, and transmits the output of the electric motor 2 to the parking lock mechanism 4.

The pump 3 is connected to the intermediate portion of an output shaft 6 of the electric motor 2. The rotation in the first direction and the rotation in the second direction output from the electric motor 2 are directly input to the pump 3. For example, a speed reducer may be provided between the output shaft 6 and the oil pump 3. When a speed reducer is provided, the output of the electric motor 2 is input to the pump 3 after being decelerated appropriately.

The pump 3 is configured to intake and discharge a fluid when the rotation in the first direction is input. The fluid discharged from the pump 3 circulates in a closed circuit (not shown) connected to the pump 3, and is supplied to the parts of the vehicle and then returns to the pump 3 again. The pump 3 is, for example, an oil pump. Oil discharged from the oil pump is used for operations of hydraulic equipment such as a clutch mechanism and a transmission mechanism, and is used for lubrication of the parts of the vehicle. Alternatively, the pump 3 is, for example, a water pump, and cooling water discharged from the water pump is used to cool an engine, an electric motor, a control device for controlling a current, a voltage, and the like of the electric motor, and the like.

The pump 3 may be configured to intake and discharge the fluid when the rotation in the second direction is input, or may be configured not to discharge the fluid. The operation of the pump 3 when the rotation in the second direction is input is appropriately set according to the characteristics of the device that receives the supply of the fluid from the pump 3. “Not to discharge the fluid” means not to apply a pressure for circulating through the closed circuit to the fluid.

The one-way clutch 5 is connected to the output shaft 6 closer to the distal end of the output shaft 6 than is the pump 3. The one-way clutch 5 is configured to block the rotation in the first direction and transmit the rotation in the second direction. In the example shown in FIG. 1, a planetary gear unit 7 is provided between the output shaft 6 and the one-way clutch 5. The output of the electric motor 2 is input to the one-way clutch 5 after being decelerated appropriately. The pump 3, the planetary gear unit 7, and the one-way clutch 5 are disposed coaxially along the output shaft 6, which saves the space required for installing the driving apparatus 1.

The parking lock mechanism 4 includes a shift drum 10 to which rotation is transmitted via the one-way clutch 5, and a shift fork 11 engaged with the shift drum 10. The one-way clutch 5 is configured to transmit only the rotation in the second direction. The shift drum 10 rotates only in one direction in response to the rotation in the second direction transmitted via the one-way clutch 5. The shift drum 10 has a cylindrical tubular shape. The outer peripheral surface of the shift drum 10 is provided with an endless cam groove 12 circling in one direction.

The shift fork 11 is movable in the direction along the central axis of the shift drum 10. A first end of the shift fork 11 is engaged with the cam groove 12. The shift fork 11 follows the cam groove 12 while moving in the direction along the central axis of the shift drum 10 in response to the rotation of the shift drum 10. The shift fork 11 has a plurality of operating states including a first state and a second state. Each operating state is determined based on the position of the shift fork 11 in the direction along the central axis of the shift drum 10. The first state corresponds to the locked state of the parking lock mechanism 4, and the second state corresponds to the unlocked state of the parking lock mechanism 4.

The parking lock mechanism 4 includes a swing arm 13 that engages with the shift fork 11, a lock arm 14 that engages with the swing arm 13, and a disc-shaped lock wheel 15 that rotates together with the wheel. These elements lock and unlock the parking lock in accordance with the operating state of the shift fork 11.

The intermediate portion of the swing arm 13 is swingably supported by a shaft 16. A first end of the swing arm 13 is engaged with a second end of the shift fork 11, and a second end of the swing arm 13 is engaged with a first end of the lock arm 14. A second end of the lock arm 14 is swingably supported by a shaft 17. A lock pin 18 projects from the intermediate portion of the lock arm 14. The lock pin 18 can engage with an engagement groove 19 formed in the outer periphery of the lock wheel 15. The lock arm 14 is biased by a torsion spring (not shown) wound around the shaft 17. The torsion spring constantly biases the lock arm 14 in a rotation direction in which the first end of the lock arm 14 and the second end of the swing arm 13 are engaged with each other and the lock pin 18 is disengaged from the engagement groove 19 (CW direction).

When the shift fork 11 transitions from the first state to the second state, the shift fork 11 moves backward with respect to the swing arm 13. The lock arm 14 biased in the CW direction presses the swing arm 13, and the swing arm 13 rotates clockwise around the shaft 16. Then, the lock arm 14 engaged with the swing arm 13 rotates in the CW direction around the shaft 17, and the lock pin 18 of the lock arm 14 is disengaged from the engagement groove 19 of the lock wheel 15 as indicated by the broken line in FIG. 1. As a result, the parking lock mechanism 4 is in the unlocked state, and the wheel is rotatable together with the lock wheel 15.

Conversely, when the shift fork 11 transitions from the second state to the first state, the shift fork 11 moves forward with respect to the swing arm 13, and rotates the swing arm 13 in the counterclockwise direction around the shaft 16. Then, the lock arm 14 engaged with the swing arm 13 rotates in the CCW direction around the shaft 17, and the lock pin 18 of the lock arm 14 engages with the engagement groove 19 of the lock wheel 15 as indicated by the solid line in FIG. 1. As a result, the parking lock mechanism is in the locked state, and the rotation of the wheel is prevented together with the lock wheel 15.

The shift fork 11 alternately transitions between the first state and the second state in response to the rotation of the shift drum 10 in one direction.

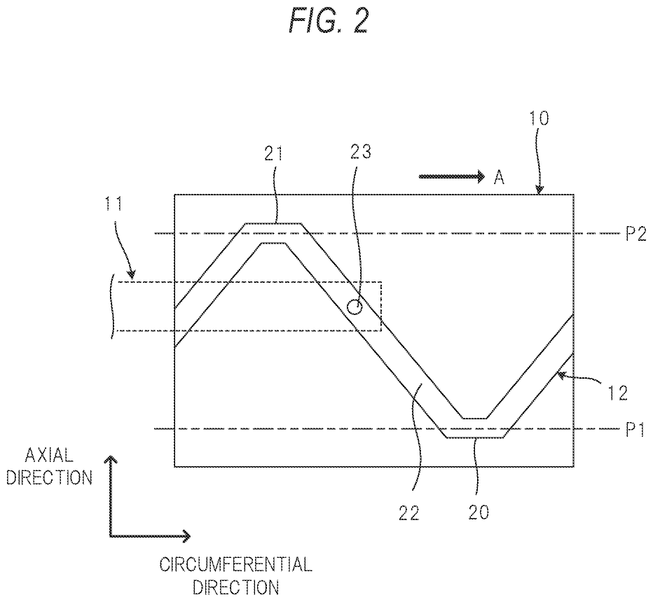

FIG. 2 shows a configuration of the shift drum 10.

The shift drum 10 is a cylindrical tubular shape member. The outer peripheral surface of the shift drum 10 is provided with the endless cam groove 12 circling in one direction. FIG. 2 shows the configuration of the cam groove 12 with the outer peripheral surface of the shift drum 10 being developed in a planar shape.

The cam groove 12 is provided with a first stationary portion 20 and a second stationary portion 21. Here, a stationary portion of the cam groove 12 refers to a portion where the position of the groove in the direction along the central axis of the shift drum 10 does not change over a predetermined distance in the circumferential direction of the shift drum 10. Assuming that the position of the first stationary portion 20 in the direction along the central axis is P1, the second stationary portion 21 is arranged in a position P2 different from the position P1. The first stationary portion 20 and the second stationary portion 21 are alternately provided along the cam groove 12. One first stationary portion 20 and one second stationary portion 21 adjacent to each other in the circumferential direction of the shift drum 10 are connected by a connecting portion 22 of the cam groove 12.

When the shift drum 10 rotates in one direction (A direction), an engagement portion 23 of the shift fork 11 with the cam groove 12 (the first end of the shift fork 11) moves relatively along the cam groove 12. At this time, the engagement portion 23 of the shift fork 11 is pushed against the side surface of the cam groove 12, and the shift fork 11 is moved in the direction along the central axis of the shift drum 10. The state in which the engagement portion 23 of the shift fork 11 is positioned in the first stationary portion 20 corresponds to the first state of the shift fork 11, in which the parking lock mechanism 4 is in the locked state. The state in which the engagement portion 23 of the shift fork 11 is positioned in the second stationary portion 21 corresponds to the second state of the shift fork 11, in which the parking lock mechanism 4 is in the unlocked state.

While the shift drum 10 rotates for one full rotation in one direction (the A direction), the engagement portion 23 of the shift fork 11 moves from the first stationary portion 20 to the second stationary portion 21 while moving in the cam groove 12 in the one direction, and then returns from the second stationary portion 21 to the first stationary portion 20. As a result, the shift fork 11 alternately transitions between the first state and the second state in accordance with the rotation of the shift drum 10 in the one direction. In accordance with such state transition of the shift fork 11, the parking lock mechanism 4 is alternately switched between the locked state and the unlocked state.

In the example illustrated in FIG. 2, one first stationary portion 20 and one second stationary portion 21 are provided in the cam groove 12, but a plurality of first stationary portions 20 and the same number of second stationary portions 21 may be provided in the cam groove. In the case where a plurality of first stationary portions 20 and a plurality of second stationary portions 21 are provided, assuming the state transition from the first state through the second state to the first state again as one cycle, such state transition of one cycle is repeated a plurality of times while the shift drum 10 rotates for one full rotation in the one direction (A direction). Further, the connecting portion 22 is formed in a straight line shape in the developed view of FIG. 2, but may be formed in a curved shape.

According to the driving apparatus 1 described above, the pump 3 and the parking lock mechanism 4 are driven by a single electric motor 2. This simplifies the structure, reduces the weight, and reduces the cost. Further, according to the driving apparatus 1, the pump 3 is driven by the rotation of the electric motor 2 in the first direction, and the parking lock mechanism 4 is driven by the rotation in the second direction. That is, the pump 3 and the parking lock mechanism 4 are driven independently of each other. Accordingly, for example, the response of the pump 3 and the parking lock mechanism 4 can be improved.

The actuator of the driving apparatus 1 described above is not limited to application to the parking lock mechanism 4. As another application example of the actuator of the driving apparatus 1, a clutch mechanism is exemplified. The clutch mechanism can select between two states including a connected state and a disconnected state. When the actuator is applied to the clutch mechanism, the clutch mechanism is connected in the first state of the shift fork 11, and the clutch mechanism is disconnected in the second state.

The actuator of the driving apparatus 1 may have a third state in addition to the first state and the second state of the shift fork 11. An example in which such an actuator is applied to a transmission mechanism is exemplified. Hereinafter, a configuration example of the shift drum in a case where the shift fork 11 further has the third state in addition to the first state and the second state will be described by taking a transmission mechanism as an example.

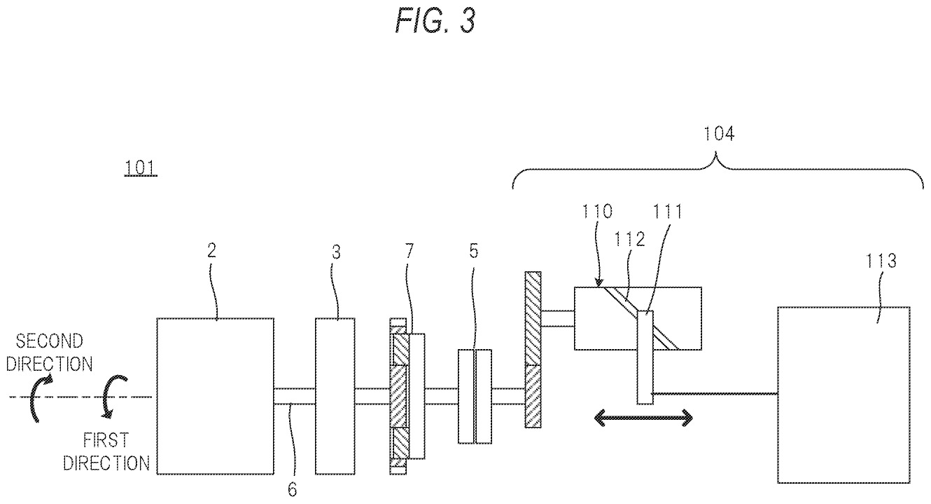

FIG. 3 illustrates another example of the driving apparatus. The elements the same as those of the driving apparatus 1 illustrated in FIG. 1 are denoted by the same reference numerals, and the description thereof will be simplified or omitted.

The driving apparatus 101 includes the electric motor 2, the pump 3, the transmission mechanism 104 which is an actuator, and the one-way clutch 5. The one-way clutch 5 is provided between the electric motor 2 and the transmission mechanism 104, and transmits the output of the electric motor 2 to the transmission mechanism 104.

The pump 3 is configured to intake and discharge a fluid when at least the rotation in the first direction is input. The one-way clutch 5, which transmits the output of the electric motor 2 to the transmission mechanism 104, is configured to block the rotation in the first direction and transmit the rotation in the second direction.

The transmission mechanism 104 includes a shift drum 110 to which rotation is transmitted via the one-way clutch 5, and a shift fork 111 engaged with the shift drum 110. The one-way clutch 5 is configured to transmit only the rotation in the second direction. The shift drum 110 rotates only in one direction in response to the rotation in the second direction transmitted via the one-way clutch 5. The shift drum 110 is a cylindrical tubular shape member. The outer peripheral surface of the shift drum 110 is provided with an endless cam groove 112 circling in one direction.

The shift fork 111 is movable in the direction along the central axis of the shift drum 110. A first end of the shift fork 111 is engaged with the cam groove 112. The shift fork 111 follows the cam groove 112 while moving in the direction along the central axis of the shift drum 110 in response to the rotation of the shift drum 110.

A second end of the shift fork 111 is connected to a gear box 113 of the transmission mechanism 104. Here, the gearbox 113 is configured to be set to any one of “first gear”, “second gear”, and “third gear” with different transmission ratios. The shift fork 111 has a plurality of operating states including a first state, a second state and a third state. Each operating state is determined based on the position of the shift fork 111 in the direction along the central axis of the shift drum 110. The first state corresponds to “first gear” having the largest transmission ratio, the second state corresponds to “third gear” having the lowest transmission ratio, and the third state corresponds to “second gear” having the intermediate transmission ratio.

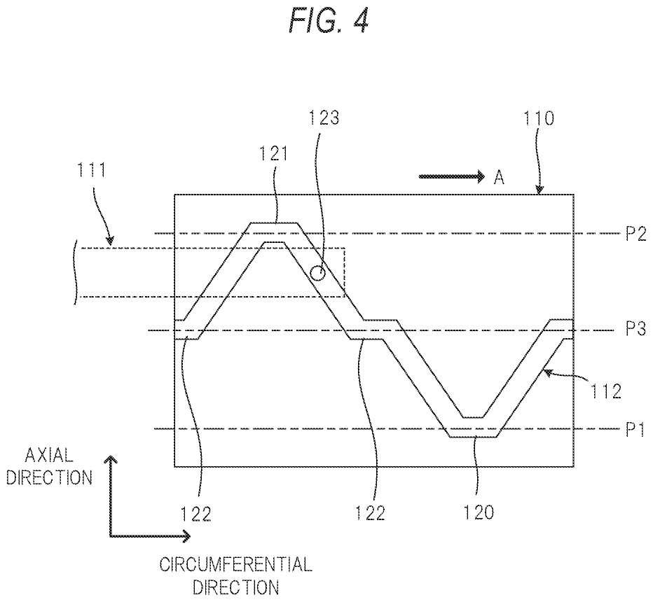

FIG. 4 shows a configuration example of the shift drum 110. FIG. 4 shows the configuration of the cam groove 112 with the outer peripheral surface of the shift drum 110 being developed in a planar shape.

The cam groove 112 is provided with a first stationary portion 120, a second stationary portion 121, and a third stationary portion 122. Assuming that the position of the first stationary portion 120 in the direction along the central axis is P1, the second stationary portion 121 is arranged in a position P2 different from the position P1, and the third stationary portion 122 is arranged in a position P3 between the position P1 and the position P2. The first stationary portion 120 and the second stationary portion 121 are alternately arranged along the cam groove 112. The third stationary portion 122 is provided between the first stationary portion 120 and the second stationary portion 121. That is, the first stationary portion 120, the third stationary portion 122, the second stationary portion 121, the third stationary portion 122, and the first stationary portion 120 are provided in this order.

When the shift drum 110 rotates in one direction (A direction), an engagement portion 123 of the shift fork 111 with the cam groove 112 moves relatively along the cam groove 112. At this time, the engagement portion 123 of the shift fork 111 is pushed against the side surface of the cam groove 112, and the shift fork 111 is moved in the direction along the central axis of the shift drum 110. The state in which the engagement portion 123 of the shift fork 111 is positioned in the first stationary portion 120 corresponds to the first state of the shift fork 111, in which the transmission mechanism 104 is set to “first gear”. The state in which the engagement portion 123 of the shift fork 111 is positioned in the second stationary portion 121 corresponds to the second state of the shift fork 111, in which the transmission mechanism 104 is set to “third gear”. The state in which the engagement portion 123 of the shift fork 111 is positioned in the third stationary portion 122 corresponds to the third state of the shift fork 111, in which the transmission mechanism 104 is set to “second gear”.

While the shift drum 110 rotates for one full rotation in the one direction (A direction), the engagement portion 123 of the shift fork 111 moves in the order of the first stationary portion 120, the third stationary portion 122, the second stationary portion 121, the third stationary portion 122, and the first stationary portion 120 while moving in the cam groove 112 in the one direction. As a result, in accordance with the rotation of the shift drum 110 in the one direction, the shift fork 111 transitions from the first state through the third state to the second state, and then transitions from the second state through the third state to the first state. In accordance with the state transition of the shift fork 111, the transmission mechanism 104 shifts from “first gear” through “second gear” to “third gear”, and then shifts from “third gear” through “second gear” to “first gear”.

In the example shown in FIG. 4, the transmission mechanism 104 shifts gears by one stage when shifting into a higher gear or a lower gear, but may directly shift from “third gear” to “first gear” without going through “second gear” when shifting to a lower gear, for example.

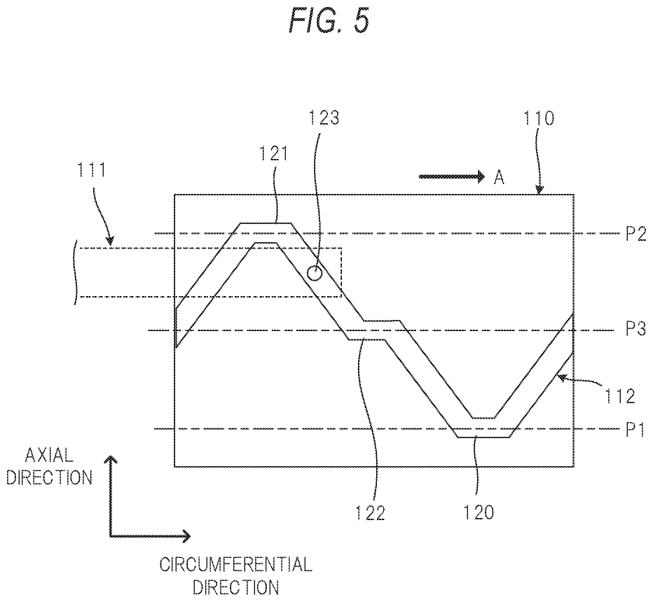

In the example illustrated in FIG. 5, the first stationary portion 120, the third stationary portion 122, the second stationary portion 121, and the first stationary portion 120 are provided in this order. While the shift drum 110 rotates for one full rotation in the one direction (A direction), the engagement portion 123 of the shift fork 111 moves in the order of the first stationary portion 120, the third stationary portion 122, the second stationary portion 121, and the first stationary portion 120 while moving in the cam groove 112 in the one direction. As a result, in accordance with the rotation of the shift drum 110 in the one direction, the shift fork 111 transitions from the first state through the third state to the second state, and then transitions from the second state to the first state without going through the third state. In accordance with the state transition of the shift fork 111, the transmission mechanism 104 shifts from “first gear” through “second gear” to “third gear”, and then directly shifts from “third gear” to “first gear”.

1. A driving apparatus comprising:
a rotary electric machine configured to output rotation in a first direction and rotation in a second direction opposite to the first direction;
a fluid pump and an actuator that are configured to operate with the output of the rotary electric machine as power; and
a one-way clutch provided between the rotary electric machine and the actuator and configured to transmit the output of the rotary electric machine to the actuator, wherein
the fluid pump is configured to intake and discharge a fluid when at least the rotation in the first direction is input,
the one-way clutch is configured to block the rotation in the first direction and transmit the rotation in the second direction,
the actuator includes
a shift drum configured to rotate in one direction in response to the rotation in the second direction transmitted via the one-way clutch, and
a shift fork engaged with the shift drum,
the shift fork has a plurality of operating states including at least a first state and a second state, and
the shift fork alternately transitions between the first state and the second state in response to the rotation of the shift drum in the one direction.

2. The driving apparatus according to claim 1, wherein
the shift drum has a tubular shape and has an outer peripheral surface provided with an endless cam groove circling in the one direction,
the cam groove is provided with a plurality of stationary portions whose positions in a direction along a central axis of the shift drum do not change over a predetermined distance in a circumferential direction of the shift drum,
the plurality of stationary portions includes a first stationary portion and a second stationary portion disposed at a position different from the first stationary portion in the direction along the central axis of the shift drum,
the first stationary portion and the second stationary portion are alternately provided along the cam groove,
the shift fork is configured to move in the direction along the central axis of the shift drum and is engaged with the cam groove,
the shift fork is in the first state when the shift fork is engaged with the first stationary portion, and
the shift fork is in the second state when the shift fork is engaged with the second stationary portion.

3. The driving apparatus according to claim 1, wherein
the plurality of operating states further includes a third state, and
the shift fork transitions from the first state to the second state via the third state and transitions from the second state to the first state via the third state in response to the rotation of the shift drum in the one direction.

4. The driving apparatus according to claim 3, wherein
the shift drum has a tubular shape and has an outer peripheral surface provided with an endless cam groove circling in the one direction,
the cam groove is provided with a plurality of stationary portions whose positions in a direction along a central axis of the shift drum do not change in a circumferential direction of the shift drum,
the plurality of stationary portions include a first stationary portion, a second stationary portion disposed at a position different from the first stationary portion in the direction along the central axis of the shift drum, and a plurality of third stationary portions disposed at positions different from the first stationary portion and the second stationary portion in the direction along the central axis of the shift drum,
the first stationary portion, the second stationary portion, and the plurality of third stationary portions are provided along the cam groove in order of the first stationary portion, one of the plurality of third stationary portions, the second stationary portion, and another of the plurality of third stationary portions,
the shift fork is configured to move in the direction along the central axis of the shift drum and is engaged with the cam groove,
the shift fork is in the first state when the shift fork is engaged with the first stationary portion,
the shift fork is in the second state when the shift fork is engaged with the second stationary portion, and
the shift fork is in the third state when the shift fork is engaged with any one of the plurality of third stationary portions.

5. The driving apparatus according to claim 1, wherein
the plurality of operating states further include a third state, and
the shift fork transitions from the first state to the second state via the third state and transitions from the second state to the first state skipping the third state in response to the rotation of the shift drum in the one direction.

6. The driving apparatus according to claim 3, wherein
the shift drum has a cylindrical tubular shape and has an outer peripheral surface provided with an endless cam groove circling in the one direction,
the cam groove is provided with a plurality of stationary portions whose positions in a direction along a central axis of the shift drum do not change in a circumferential direction of the shift drum,
the plurality of stationary portions include a first stationary portion, a second stationary portion disposed at a position different from the first stationary portion in the direction along the central axis of the shift drum, and a third stationary portions disposed at positions different from the first stationary portion and the second stationary portion in the direction along the central axis of the shift drum,
the first stationary portion, the second stationary portion, and the third stationary portion are provided along the cam groove in order of the first stationary portion, the third stationary portion, and the second stationary portion,
the shift fork is configured to move in the direction along the central axis of the shift drum and is engaged with the cam groove,
the shift fork is in the first state when the shift fork is engaged with the first stationary portion,
the shift fork is in the second state when the shift fork is engaged with the second stationary portion, and
the shift fork is in the third state when the shift fork is engaged with the third stationary portion.

7. The driving apparatus according to claim 1, wherein
the actuator operates a parking lock of a vehicle,
the parking lock is locked in the first state, and
the lock of the parking lock is released in the second state.

8. The driving apparatus according to claim 1, wherein
the actuator operates a clutch of the vehicle,
the clutch is connected in the first state, and
the clutch is disconnected in the second state.

9. The driving apparatus according to claim 3, wherein
the actuator actuates a transmission of the vehicle, and
the transmission is set to different transmission ratios according to the first state, the second state, and the third state.

10. The driving apparatus according to claim 5, wherein
the actuator actuates a transmission of the vehicle, and
the transmission is set to different transmission ratios according to the first state, the second state, and the third state.
